(19) United States
(12) Patent Application Publication
(10) Pub. No.: US 2012/0028874 A1
(43) Pub. Date: Feb. 2, 2012

(54) PARTICLES

(76) Inventors: Susana FERNANDEZ PRIETO, Benicarlo-Castellon (ES); Johan Smets, Lubbeek (BE); Yousef Georges Aouad, Cincinnati, OH (US); Jean Wevers, Koksijde (BE); Piero Baglioni, Fiesole (IT); Moira Ambrosi, Sesto (IT); Chiara Vannucci, Pistoia (IT)

(21) Appl. No.: 13/186,528

(22) Filed: Jul. 20, 2011

Related U.S. Application Data
(60) Provisional application No. 61/365,896, filed on Jul. 20, 2010.
(60) Provisional application No. 61/367,990, filed on Jul. 27, 2010.

(51) Int. Cl. C11D 17/08; B65D 85/84; B08B 7/00; D06L 1/00

(52) U.S. Cl. 510/375; 510/438; 510/392; 8/137; 206/524.7; 134/7

(57) ABSTRACT

The present application relates to particles comprising a benefit agent encapsulated by a first layer that is in turn encapsulated by a second material, and products comprising such particles, as well as processes for making and using such particles and products comprising such particles. The process of making such particles does not unduly degrade the benefit agent and when such particles are employed in a product, they are stable, yet they release the desired amount of benefit agent when such product is used as intended.

### CROSS-REFERENCE TO RELATED APPLICATIONS

This application claims priority under 35 U.S.C. §119(e) to U.S. Provisional Application Ser. No. 61/365,896 filed on Jul. 20, 2010, and U.S. Provisional Application Ser. No. 61/367,990 filed on Jul. 27, 2010.

### FIELD OF INVENTION

The present application relates to particles comprising benefit agents, and products comprising such particles, as well as processes for making and using such particles and products comprising such particles.

### BACKGROUND OF THE INVENTION

Products, for example, consumer products may comprise one or more benefit agents that can provide a desired benefit to such product and/or a situs that is contacted with such a product—for example stain removal and/or bleaching. Unfortunately, in certain products, for example, fluid products, benefit agents such as preformed peracids may be degraded by or degrade components of such products before such product is used—this is particularly true when the product has a pH greater than about 6. Thus, a protection system that protects the components of a product from a benefit agent is desired. Efforts have been made in this area but typically either fail to provide the required level of protection or fail to release the benefit agent when it is needed. Thus, the need for encapsulated benefit agents that are available during product use, yet which do not damage such product during product storage remains. Applicants disclose a particle comprising a benefit agent, such as preformed peracids, wherein the benefit agent is encapsulated by a first material that forms a first layer and said first layer is encapsulated by a second material that forms a second layer. While not being bound by theory, Applicants believe that the second layer serves as a barrier that separates the particle from its environment, for example, a liquid detergent environment, and the first layer serves as a material sink that absorbs any material from the particle's environment that successfully penetrates, by diffusion or any other means, through the second layer. Such particles are stable in a product, such as a consumer product, during storage, yet, as needed, such particles release the encapsulated benefit agent during the product's use. Surprisingly, the process of making such particles does not unduly degrade the benefit agent and when such particles are employed in a product, they are stable, yet they release the desired amount of benefit agent when such product is used as intended.

### SUMMARY OF THE INVENTION

The present application relates to particles comprising a benefit agent encapsulated by a first layer that is in turn encapsulated by a second material, and products comprising such particles, as well as processes for making and using such particles and products comprising such particles.

### BRIEF DESCRIPTION OF THE DRAWINGS

FIG. 1 depicts a representative particle having a core encapsulated by a dual shell system.

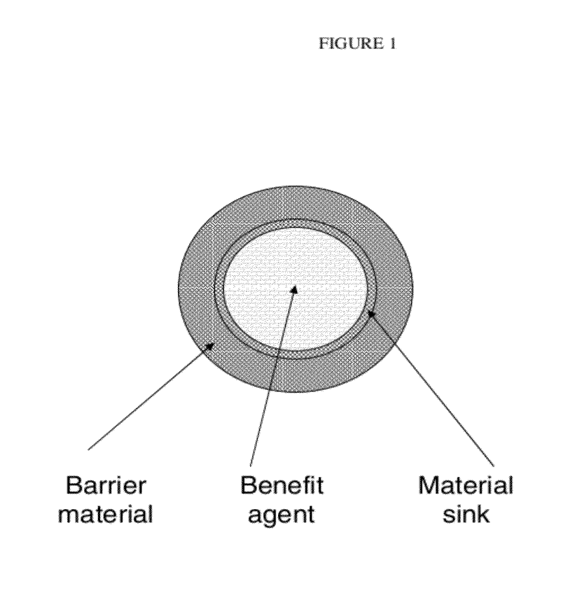

### DETAILED DESCRIPTION OF THE INVENTION

### Definitions

As used herein “consumer product” means baby care, beauty care, fabric & home care, family care, feminine care, or devices generally intended to be used in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening.

As used herein, the term “cleaning and/or treatment composition” is a subset of consumer products that includes, unless otherwise indicated, beauty care, fabric & home care products. Such products include, but are not limited to, products for treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Consumer Products

In one aspect a particle comprising a shell and a core, said shell comprising at least a first layer, and a second layer, said first layer encapsulating said core and comprising a material sink, said second layer encapsulating said first layer and comprising a barrier material, said particle having a particle diameter of from about 150 microns to about 3000 microns, from about 500 microns to about 2000 microns, or even from about 750 microns to about 1500 microns is disclosed.

In one aspect of said particle, said material sink may comprise a sink for small molecules, said molecules may have a molecular weight from about 500 grams/mol to about 18 grams/mol, from about 300 grams/mol to about 18 grams/mol, or even from about 100 grams/mol to about 28 grams/mol. In one aspect, said small molecules may be selected from water, an organic material and mixtures thereof. In one aspect, said organic material may be selected from the group consisting of ethanol, propylene glycol, ethyl acetate, trans-2-hexanal, cis-3 hexenol, methyl heptenone, cinnamalva, benzaldehyde, benzyl alcohol and mixtures thereof. Without being limited by theory, it is believed that small molecules are drawn into the network across a diffusion gradient, said network formed by the material sink, and said material sink swells and may even promote sealing of the interface between the first layer and the second layer. Swelling can be measured using the centrifuge retention test method further detailed hereinafter.

In one aspect of said particle:
a) said material sink may comprise a material selected from a water soluble and/or water dispersible non-reducing polysaccharide, a water soluble and/or water dispersible acrylate derivative and mixtures thereof;
b) said barrier material may comprise a material selected from the group consisting of polyvinyl alcohol, polyvinyl acetate, cellulose acetate, poly(vinyl-alcohol-co-vinylacetate), acrylic acid-ethylene-vinyl acetate copolymer and mixtures thereof; and
c) said core material may comprise a material selected from the group consisting of a preformed peracid, a metal catalyst, a bleach activator, a bleach booster, a diacyl peroxide, a hydrogen peroxide source and an enzyme.

In one aspect of said particle:
a) said metal catalyst may comprise a material selected from the group consisting of dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II) and mixtures thereof;
b) said bleach booster may comprise material selected from the group consisting of 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl]isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfooxy)propyl]isoquinolinium, inner salt; 2-[3-[(2-ethylhexyl)oxy]-2-(sulfooxy)propyl]-3,4-dihydroisoquinolinium, inner salt and mixtures thereof;
c) said bleach activator may comprise a material selected from the group consisting of tetraacetyl ethylene diamine (TAED); benzoylcaprolactam (BzCL); 4-nitrobenzoylcaprolactam; 3-chlorobenzoyl-caprolactam; benzoyloxybenzenesulphonate (BOBS); nonanoyloxybenzene-sulphonate (NOBS); phenyl benzoate (PhBz); decanoyloxybenzenesulphonate (C₁₀-OBS); benzoylvalerolactam (BZVL); octanoyloxybenzenesulphonate (C₈-OBS); perhydrolyzable esters; 4-[N-(nonaoyl)amino hexanoyloxy]-benzene sulfonate sodium salt (NACA-OBS); dodecanoyloxybenzenesulphonate (LOBS or C₁₂-OBS); 10-undecenoyloxybenzenesulfonate (UDOBS or C₁₁-OBS with unsaturation in the 10 position); decanoyloxybenzoic acid (DOBA); (6-octanamidocaproyl)oxybenzenesulfonate; (6-nonanamidocaproyl)oxybenzenesulfonate; (6-decanamidocaproyl)oxybenzenesulfonate and mixtures thereof;
d) said preformed peracid may comprise a material selected from the group consisting of peroxymonosulfuric acids; perimidic acids; percabonic acids; percarboxilic acids and salts of said acids; in one aspect, said percarboxilic acids and salts thereof may comprise phthalimidoperoxyhexanoic acid, 1,12-diperoxydodecanedioic acid; or monoperoxyphthalic acid (magnesium salt hexahydrate); amidoperoxyacids, in one aspect, said amidoperoxyacids may comprise N,N′-terephthaloyl-di(6-aminocaproic acid), a monononylamide of either peroxysuccinic acid (NAPSA) or of peroxyadipic acid (NAPAA), N-nonanoylaminoperoxycaproic acid (NAPCA), and mixtures thereof; in one aspect, said preformed peracid may comprise phthalimidoperoxyhexanoic acid; suitable phthalimidoperoxyhexanoic acids includes EURECO™ W, EURECO™ M, EURECO™ MG and mixtures thereof;
e) said diacyl peroxide may comprise a material selected from the group consisting of dinonanoyl peroxide, didecanoyl peroxide, diundecanoyl peroxide, dilauroyl peroxide, dibenzoyl peroxide, di-(3,5,5-trimethyl hexanoyl)peroxide and mixtures thereof; in one aspect, said diacyl peroxide may comprise a clathrated diacyl peroxide;
f) said hydrogen peroxide source may comprise a material selected from the group consisting of a perborate, a percarbonate, a peroxyhydrate, a persulfate and mixtures thereof, in one aspect said hydrogen peroxide source may comprise sodium perborate, in one aspect said sodium perborate may comprise a mono- or tetra-hydrate, sodium pyrophosphate peroxyhydrate, urea peroxyhydrate or trisodium phosphate peroxyhydrate and mixtures thereof; and
g) said enzyme may comprise a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, and mixtures thereof.

In one aspect of said particle, said core may comprise a combination of said core materials. In one aspect, said core materials may be agglomerated. In one aspect, said combination of said core materials being encapsulated by said material sink and barrier material.

In one aspect of said particle:
a) said polyvinyl alcohol may comprise a polyvinyl alcohol variant having a degree of hydrolysis from about 80 mol % to about 99 mol %, or from about 87 mol % to about 89 mol %; and a molecular weight from about 10,000 gram/mol to about 750,000 gram/mol, or from about 30,000 gram/mol to about 300,000 gram/mol.
b) said polyvinyl acetate may comprise a polyvinyl acetate variant having a degree of polymerization from about 150 to 5,000, from about 150 to 2,000 or even from about 190 to about 1,000.
c) said cellulose acetate may comprise a cellulose acetate variant having a molecular weight from about 30,000 to about 50,000 gram/mol.

In one aspect of said barrier material, said barrier material may comprise a material that is not pH sensitive in the pH range of from about 4 to about 9.

In one aspect of said barrier material, said barrier material may comprise a good film forming polymer.

In one aspect of said barrier material, said barrier material may comprise a polymer with a dielectric constant from about 3.2 to about 9.3.

In one aspect of said particle, said barrier material may additionally comprise an organoclay that reduces the dielectric constant of the aforementioned polymer. A suitable organoclay may comprise a montmorillonite clay that has been organically modified, for example with a fatty amine.

In one aspect of said particle:
a) said water soluble and/or water dispersible non-reducing polysaccharide may comprise a material selected from the group consisting of xanthan gum, diutan gum, guar gum, gellan gum, carrageenan, synergistic gum systems and mixtures thereof. Suitable xanthan gums include Kelzan® ASX-T, Kelzan® ASX, Kelzan® HP-T, Ticaxan®, suitable gellan gums include Kelcogel® CG-LA, Kelcogel® CG-HA, suitable carrageenan gums include Genuvisco®, Genugel®, suitable synergistic gum systems include Action gum; and
b) said water soluble and/or water dispersible acrylate derivative may have a glass transition temperature from about 50° C. to about 130° C., or even from about 90° C. to about 115° C. Without being limited by theory, it is believed that water soluble and/or water dispersible acrylate derivatives have better film forming properties and a higher swelling capacity when the temperature during the particle's making process is below the glass transition temperature of such materials. Suitable acrylate derivatives include Alcogum® L-31, Alcogum® L-229, Alcogum® L-299, Alcogum® 1370, Alcogum® L-255, Alcogum® L-237, Alcogum® L-251, Alcogum® L-296-W, Acusol™ 820, and Acusol™ 801S.

In one aspect of said particle, said material sink may comprise a material that is a solid at a temperature of from about 20° C. to about 150° C., or even from about 60° C. to about 150° C.

In one aspect of said material sink, said material sink may have a centrifuge retention capacity from about 2 gram/gram to about 500 gram/gram, from about 10 gram/gram to about 300 gram/gram, or even from about 50 gram/gram to about 150 gram/gram.

In one aspect of said sink material, said sink material may comprise an anionic non-reducing polysaccharide.

In one aspect of said particle, said material sink may comprise an anionic non-reducing polysaccharide that may be encapsulated with a barrier material capable of masking the (negative) charge of said anionic non-reducing polysaccharide, such as a barrier material comprising a polymer with a dielectric constant from about 3.2 to about 8.3.

In one aspect of said particle, said particle may have a stability index of from about 0.80 to about 1, from about 0.90 to about 1, or even from about 0.95 to about 1.

In one aspect of said particle, said particle may have a release index of from about 0.25 to about 1, from about 0.50 to about 1, or even from about 0.85 to about 1.

In one aspect of said particle, said particle may have a core to shell mass ratio of from about 5:95 to about 80:20, from about 15:85 to about 60:40, or even from about 25:75 to about 50:50.

In one aspect of said particle, said particle may have a material sink to barrier material mass ratio of from about 20:80 to about 3:97 or even from about 15:85 to 10:90.

In one aspect of said particle, said particle may comprise a third layer, said third layer may comprise a second barrier material. In one aspect, said third layer may be positioned between said first and second layer. In another aspect, said third layer may encapsulate the outer surface of said second layer. In one aspect, said second barrier material may comprise polyvinyl alcohol, polyvinyl acetate, cellulose acetate, poly(vinyl-alcohol-co-vinylacetate), acrylic acid-ethylene-vinyl acetate copolymer, shellac, hydroxypropylmethyl cellulose phthalate, cellulose acetate phthalate and mixtures thereof.

In one aspect of a consumer product, said consumer product may comprise said particle and an adjunct ingredient.

In one aspect of said consumer product, said consumer product may comprise at least 75%, 85% or even 90% of said particles comprising a particle wall thickness of from about 1 to about 500 microns, from about 20 microns to about 250 microns, or even from about 50 microns to about 150 microns.

In one aspect of said consumer product, said consumer product may comprise a material selected from the group consisting of an external structuring system, an anti-agglomeration agent and mixtures thereof.

In one aspect of said consumer product, said external structuring system is a hydrogenated castor oil derivative.

In one aspect of said consumer product, said consumer product may comprise a material selected from
a) an anionic surfactant and/or a nonionic, in one aspect an anionic surfactant;
b) a solvent, in one aspect said solvent may comprise butoxypropoxypropanol and/or glycerol;
c) water, in one aspect, based on total composition weight, less than about 10% water, or from about 2% to about 10% water;
d) optionally, one or more materials selected from the group consisting of:
   i. a bleach compatible clay clean polymer, in one aspect said bleach compatible clay clean polymer may be selected from the group consisting of ethoxylated hexamethylene diamine dimethyl quat, ethoxysulfated hexamethylene diamine dimethyl quat and mixtures thereof.
   ii. a brightener, in one aspect said brightener may comprise a fluorescent brightener selected from disodium 4,4′-bis(2-sulfostyryl)biphenyl and/or bis(sulfobenzofuranyl)biphenyl.
   iii. a builder, in one aspect said builder may comprise sodium citrate
   iv. a chelant, in one aspect said chelant may comprise 1-Hydroxy Ethylidene-1,1-Diphosphonic Acid (HEDP)

In one aspect of said consumer product, said consumer product may comprise:
a) from 0.0001% to 8% by weight of a detersive enzyme, and
b) a neat pH from 6.5 to 10.5.

In one aspect of said consumer product, said detersive enzyme may comprise an enzyme selected from the group consisting of lipase, protease, amylase, cellulase, pectate lyase, xyloglucanase, and mixtures thereof.

In one aspect of said consumer product, said consumer product may comprise:
a) from 0.1% to 12% by weight of the bleach or bleach system, and
b) a neat pH of from 6.5 to 10.5.

In one aspect of said consumer product, said consumer product may be enclosed within a water soluble a pouch material, in one aspect, said pouch material may comprise polyvinyl alcohol, a polyvinyl alcohol copolymer, hydroxypropyl methyl cellulose (HPMC), and mixtures thereof.

The suitable materials and equipment for practicing the present invention may be obtained from: Germany SSB, Stroever GmbH & Co. KG, Muggenburg 11, 28217 Bremen, Germany; Sigma Aldrich NV/SA, Kardinaal Cardijnplein 8, 2880 Bornem, Belgium; ProCepT nv, Rosteyne 4, 9060 Zelzate, Belgium; GEA Process Engineering Inc. • 9165 Rumsey Road • Columbia, Md. 21045, US; Mettler-Toledo, Inc., 1900 Polaris Parkway, Columbus, Ohio, 43240, US; IKA-Werke GmbH & Co. KG, Janke & Kunkel Str. 10, 79219 Staufen, Germany; Alfa Aesar GmbH & Co KG, Zeppelinstrasse 7, 76185 Karlsruhe, Germany; Eastman Chemical Company, PO Box 431, Kingsport, Tenn. 37662, US; Glatt Ingenieurtechnik GmbH, Nordstrasse 12, 99427 Weimar, Germany; Tic Gums, White Marsh, Md. 21162, 10552 Philadelphia Rd, USA; CP Kelco B.V., Delta 1P, Business Park Ijsseloord 2, 6825 HL Arnhem, The Netherlands; Solvay Chimica Bussi, Via Marostica 1, 20146 Milano, Italy; Endecotts LTD, 9 Lombard Road, London, SW19 3TZ, United Kingdom; VWR International Eurolab S.L., C/De la Tecnologia, 5-17, A-7 Llinars Park, 08450 Llinars del Vallés, Spain, FRITSCH GmbH Telephone: 06784/70-153, Industriestrasse 8, 55743 Idar-Oberstein, Germany; Metrohm AG, Oberdorfstrasse 68, 9101 Herisau, Switzerland; Imes nv, Ekkelgaarden 26, 3500 Hasselt, Belgium; Gerhardt GmbH & Co., Caesariusstrasse 97, 52639 Koenigswinter, Germany; Kemira Chemicals, Inc., 1950 Vaughn Road, Kennesaw, Ga. 30144, United States; Cytec Industries Inc., 5 Garret Mountain Plaza, Woodland Park, N.J. 07424, United States; Harvard Apparatus, S.A.R.L, 6 Ave des Andes, Miniparc—Bat 8, 91952 Les Ulis Cedex, France.

### Process of Making Consumer Products

A process of making a consumer product, comprising a consumer product adjunct material and a particle is disclosed, said process may comprise:
a) preparing a first solution comprising, based on total solution weight, from about 0.5% to about 10% of a material sink that is suspended and/or dissolved in said first solution, and one or more solvents. In one aspect, such solvent may comprise water, ethanol, acetone, dichloromethane and mixtures thereof.
b) preparing a second solution comprising, based on total solution weight, from about 2% to about 20% of a barrier material that is suspended and/or dissolved in said second solution, and one or more solvents. In one aspect, such solvent may comprise water, ethanol, acetone, dichloromethane and mixtures thereof.
c) optionally, preparing a third solution comprising, based on total solution weight, from about 2% to about 20% of a barrier material that is suspended and/or dissolved in said third solution, and one or more solvents. In one aspect, such solvent may comprise water, ethanol, acetone, dichloromethane and mixtures thereof. In one aspect, said barrier material may comprise a material selected from the group consisting of polyvinyl alcohol, polyvinyl acetate, cellulose acetate, poly(vinyl-alcohol-co-vinylacetate), acrylic acid-ethylene-vinyl acetate copolymer, shellac, hydroxypropyl methylcellulose phthalate, cellulose acetate phthalate and/or mixtures thereof.
d) optionally, said first, second and/or third solution may comprise, based on total solution weight, from about 0.01% to about 5% of a plasticizer. Suitable plasticizers may comprise polyols such as sugars, sugar alcohols, or polyethylene glycols (PEGs), urea, glycol, propylene glycol or other known plasticizers such as triethyl citrate, dibutyl or dimethyl phthalate, polyethylene glycerin, sorbitol, tribuyl citrate, dibutyl sebecate and/or polysorbates.
e) optionally, combining an anti-agglomeration agent with said first, second and/or third solution. Suitable anti-agglomeration agents may include fine insoluble and sparingly soluble material such as talc, TiO₂, clays, silica, magnesium stearate, stearic acid and calcium carbonate.
f) optionally, forming a first composition by agglomerating said core material and a binder. In one aspect, said agglomeration process may comprise a fluid bed processing, a high shear agglomeration processing or a combination thereof. Suitable binders include natural polymers such as starch, modified starch, carrageenan, gum arabic and guar gum and synthetic polymers such as polyethylene oxide, polyvinyl pyrrolidone, polyethylene glycol and polyethylene oxide/polypropylene oxide.
g) fluidizing said core material or said first composition in a chamber at a temperature of from about 25° C. to about 90° C. In one aspect, such chamber may comprise a fluid bed coater, optionally comprising a wurster. In another aspect, said chamber may comprise a spouted bed.
h) forming a second composition by spraying said first solution on said fluidized core material or said first composition. In one aspect, said spraying process may comprise a bi-fluid nozzle.
i) fluidizing said second composition in a chamber at a temperature of from about 25° C. to about 90° C. In one aspect, such chamber may comprise a fluid bed coater, optionally comprising a wurster. In another aspect, said chamber may comprise a spouted bed.
j) forming a third composition by spraying said second solution on said second composition. In one aspect, said spraying process may comprise a bi-fluid nozzle.
k) optionally, fluidizing said third composition in a chamber at a temperature of from about 25° C. to about 90° C. In one aspect such chamber may comprise a fluid bed coater, optionally with wurster. In another aspect, said chamber may comprise spouted bed.
l) optionally, forming a fourth composition by spraying said third solution on said third composition. In one aspect, said spraying process may comprise a bi-fluid nozzle.
m) optionally, forming a fifth composition by agglomerating said third and/or fourth composition;
n) combining said third, fourth and/or fifth composition with one or more consumer product adjuncts.

In one aspect of said process of making a consumer product, said process may comprise:
a) preparing a first solution comprising, based on total solution weight, from about 0.5% to about 10% of a material sink that is suspended and/or dissolved in said first solution, and one or more solvents. In one aspect, such solvent may comprise water, ethanol, acetone, dichloromethane and mixtures thereof.
b) preparing a second solution comprising, based on total solution weight, from about 2% to about 20% of a barrier material that is suspended and/or dissolved in said second solution, and one or more solvents. In one aspect, such solvent may comprise water, ethanol, acetone, dichloromethane and mixtures thereof.
c) optionally, preparing a third solution comprising, based on total solution weight, from about 2% to about 20% of a barrier material that is suspended and/or dissolved in said third solution, and one or more solvents. In one aspect, such solvent may comprise water, ethanol, acetone, dichloromethane and mixtures thereof. In one aspect, said barrier material may comprise a material selected from the group consisting of polyvinyl alcohol, polyvinyl acetate, cellulose acetate, poly(vinyl-alcohol-co-vinylacetate), acrylic acid-ethylene-vinyl acetate copolymer, shellac, hydroxypropyl methylcellulose phthalate, cellulose acetate phthalate and/or mixtures thereof.
d) optionally, said first, second and/or third solution may comprise, based on total solution weight, from about 0.01% to about 2% of a plasticizer. Suitable plasticizers may comprise polyols such as sugars, sugar alcohols, or polyethylene glycols (PEGs), urea, glycol, propylene glycol or other known plasticizers such as triethyl citrate, dibutyl or dimethyl phthalate, polyethylene glycerin, sorbitol, tribuyl citrate, dibutyl sebecate and/or polysorbates.
e) optionally, combining an anti-agglomeration agent with said first, second and/or third solution. Suitable anti-agglomeration agents may include fine insoluble and sparingly soluble material such as talc, TiO₂, clays, amorphous silica, magnesium stearate, stearic acid and calcium carbonate.
f) optionally, forming a first composition by agglomerating said core material and a binder. In one aspect, said agglomeration process may comprise a fluid bed processing, a high shear agglomeration processing or a combination thereof. Suitable binders include natural polymers such as starch, modified starch, carrageenan, gum arabic and guar gum and synthetic polymers such as polyethylene oxide, polyvinyl pyrrolidone, polyethylene glycol and polyethylene oxide/polypropylene oxide.
g) fluidizing said core material or said first composition in a chamber at a temperature of from about 25° C. to about 90° C. In one aspect, such chamber may comprise a fluid bed coater, optionally comprising a wurster. In another aspect, said chamber may comprise a spouted bed.
h) forming a second composition by spraying said first solution on said fluidized core material or said first composition. In one aspect, said spraying process may comprise a bi-fluid nozzle.
i) optionally, fluidizing said second composition in a chamber at a temperature of from about 25° C. to about 90° C. In one aspect such chamber may comprise a fluid bed coater, optionally with wurster. In another aspect, said chamber may comprise spouted bed.
j) optionally, forming a third composition by spraying said third solution on said second composition. In one aspect, said spraying process may comprise a bi-fluid nozzle.
k) fluidizing said second or third composition in a chamber at a temperature of from about 25° C. to about 90° C. In one aspect, such chamber may comprise a fluid bed coater, optionally comprising a wurster. In another aspect, said chamber may comprise a spouted bed.
l) forming a fourth composition by spraying said second solution on said second composition. In one aspect, said spraying process may comprise a bi-fluid nozzle.
m) optionally, forming a fifth composition by agglomerating said fourth composition;
n) combining said fourth and/or fifth composition with one or more consumer product adjuncts.

### Adjunct Materials

For the purposes of the present invention, the non-limiting list of adjuncts illustrated hereinafter are suitable for use in the instant compositions and may be desirably incorporated in certain embodiments of the invention, for example to assist or enhance performance, for treatment of the substrate to be cleaned, or to modify the aesthetics of the composition as is the case with perfumes, colorants, dyes or the like. It is understood that such adjuncts are in addition to the components supplied by the recited particle. The precise nature of these additional components, and levels of incorporation thereof, will depend on the physical form of the composition and the nature of the operation for which it is to be used. Suitable adjunct materials include, but are not limited to, surfactants, builders, chelating agents, dye transfer inhibiting agents, dispersants, enzymes, and enzyme stabilizers, catalytic materials, bleach activators, polymeric dispersing agents, clay soil removal/anti-redeposition agents, brighteners, suds suppressors, dyes, additional perfume and perfume delivery systems, external structuring systems, fabric softeners, carriers, hydrotropes, processing aids and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

Each adjunct ingredient is not essential to Applicants' compositions. Thus, certain embodiments of Applicants' compositions do not contain one or more of the following adjuncts materials: bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, external structuring system, fabric softeners, carriers, hydrotropes, processing aids and/or pigments. It is understood that such adjuncts may form a product matrix that is combined with the particle disclosed herein to form a finished consumer product. Generally, when one or more adjuncts are present, such one or more adjuncts may be present as detailed below:

Surfactants—The compositions according to the present invention can comprise a surfactant or surfactant system wherein the surfactant can be selected from nonionic and/or anionic and/or cationic surfactants and/or ampholytic and/or zwitterionic and/or semi-polar nonionic surfactants. The surfactant is typically present at a level of from about 0.1%, from about 1%, or even from about 5% by weight of the cleaning compositions to about 99.9%, to about 80%, to about 35%, or even to about 30% by weight of the cleaning compositions.

Polymers—The compositions according to the present invention can comprise a polymeric dispersing agent, clay soil removal/anti-redeposition agent or mixtures thereof. In one aspect, said polymer system may comprise one or more amphiphilic alkoxylated greasy cleaning polymers, and either a clay soil cleaning polymer or a soil suspending polymer. Suitable polymer systems are described in patent US2009/0124528A1. The polymer system is typically present at a level of from about 0.1%, to about 5%, or even from about 0.3% to about 2%, or even better from about 0.6% to about 1.5% by weight of the cleaning compositions.

Builders—The compositions of the present invention can comprise one or more detergent builders or builder systems. When present, the compositions will typically comprise at least about 1% builder, or from about 5% or 10% to about 80%, 50%, or even 30% by weight, of said builder. Builders include, but are not limited to, the alkali metal, ammonium and alkanolammonium salts of polyphosphates, alkali metal silicates, alkaline earth and alkali metal carbonates, aluminosilicate builders polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Chelating Agents—The compositions herein may also optionally contain one or more copper, iron and/or manganese chelating agents. If utilized, chelating agents will generally comprise from about 0.1% by weight of the compositions herein to about 15%, or even from about 3.0% to about 15% by weight of the compositions herein.

Dye Transfer Inhibiting Agents—The compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in the compositions herein, the dye transfer inhibiting agents are present at levels from about 0.0001%, from about 0.01%, from about 0.05% by weight of the cleaning compositions to about 10%, about 2%, or even about 1% by weight of the cleaning compositions.

Dispersants—The compositions of the present invention can also contain dispersants. Suitable water-soluble organic materials are the homo- or co-polymeric acids or their salts, in which the polycarboxylic acid may comprise at least two carboxyl radicals separated from each other by not more than two carbon atoms.

Enzymes—The compositions can comprise one or more detergent enzymes which provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is a cocktail of conventional applicable enzymes like protease, lipase, cutinase and/or cellulase in conjunction with amylase.

Enzyme Stabilizers—Enzymes for use in compositions, for example, detergents can be stabilized by various techniques. The enzymes employed herein can be stabilized by the presence of water-soluble sources of calcium and/or magnesium ions in the finished compositions that provide such ions to the enzymes.

Catalytic Metal Complexes—Applicants' compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methyl-enephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936, and 5,595,967.

Compositions herein may also suitably include a transition metal complex of a macropolycyclic rigid ligand—abbreviated as “MRL”. As a practical matter, and not by way of limitation, the compositions and cleaning processes herein can be adjusted to provide on the order of at least one part per hundred million of the benefit agent MRL species in the aqueous washing medium, and may provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include manganese, iron and chromium. Suitable MRL's herein are a special type of ultra-rigid ligand that is cross-bridged such as 5,12-diethyl-1,5,8,12-tetraazabicyclo[6.6.2]hexa-decane.

Suitable transition metal MRLs are readily prepared by known procedures, such as taught for example in WO 00/32601, and U.S. Pat. No. 6,225,464.

External structuring system—The consumer product of the present invention may comprise from 0.01% to 5% or even from 0.1% to 1% by weight of an external structuring system. The external structuring system may be selected from the group consisting of:

(i) non-polymeric crystalline, hydroxy-functional structurants and/or

(ii) polymeric structurants

Such external structuring systems may be those which impart a sufficient yield stress or low shear viscosity to stabilize a fluid laundry detergent composition independently from, or extrinsic from, any structuring effect of the detersive surfactants of the composition. They may impart to a fluid laundry detergent composition a high shear viscosity at 20⁻¹ at 21° C. of from 1 cps to 1500 cps and a viscosity at low shear (0.05 s⁻¹ at 21° C.) of greater than 5000 cps. The viscosity is measured using an AR 550 rheometer from TA instruments using a plate steel spindle at 40 mm diameter and a gap size of 500 μm. The high shear viscosity at 20 s⁻¹ and low shear viscosity at 0.5 s⁻¹ can be obtained from a logarithmic shear rate sweep from 0.1 s⁻¹ to 25 s⁻¹ in 3 minutes time at 21° C. In one embodiment, the compositions may comprise from 0.01 to 1% by weight of a non-polymeric crystalline, hydroxyl functional structurant. Such non-polymeric crystalline, hydroxyl functional structurants may comprise a crystallizable glyceride which can be pre-emulsified to aid dispersion into the final unit dose laundry detergent composition. Suitable crystallizable glycerides include hydrogenated castor oil or “HCO” or derivatives thereof, provided that it is capable of crystallizing in the liquid detergent composition.

Unit dose laundry detergent compositions may comprise from 0.01 to 5% by weight of a naturally derived and/or synthetic polymeric structurant. Suitable naturally derived polymeric structurants include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Suitable synthetic polymeric structurants include: polycarboxylates, polyacrylates, hydrophobically modified ethoxylated urethanes, hydrophobically modified non-ionic polyols and mixtures thereof. In one aspect, the polycarboxylate polymer may be a polyacrylate, polymethacrylate or mixtures thereof. In another aspect, the polyacrylate may be a copolymer of unsaturated mono- or di-carbonic acid and C₁-C₃₀ alkyl ester of the (meth)acrylic acid. Such copolymers are available from Noveon inc under the tradename Carbopol® Aqua 30.

### Method of Use

Certain of the consumer products disclosed herein can be used to clean or treat a situs inter alia a surface or fabric. Typically at least a portion of the situs is contacted with an embodiment of Applicants' consumer product, in neat form or diluted in a liquor, for example, a wash liquor and then the situs may be optionally washed and/or rinsed. In one aspect, a situs is optionally washed and/or rinsed, contacted with an aspect of the consumer product and then optionally washed and/or rinsed. For purposes of the present invention, washing includes but is not limited to, scrubbing and mechanical agitation. The fabric may comprise most any fabric capable of being laundered or treated in normal consumer use conditions. Liquors that may comprise the disclosed compositions may have a pH of from about 3 to about 11.5. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1.

The employing one or more of the aforementioned methods result in a treated situs.

### TEST METHODS

It is understood that the test methods that are disclosed in the Test Methods Section of the present application should be used to determine the respective values of the parameters of Applicants' invention as such invention is described and claimed herein.

(1) Mean Particle Size for Slurries/Liquids Containing Particles in the Range of 1 to 500 Microns

The mean particle size of the particles is determined using a Lasentec M500L-3,6-K supplied by Mettler-Toledo, Inc., 1900 Polaris Parkway, Columbus, Ohio, 43240, US. The equipment is setup (Lasentec, FBRM Control Interface, version 6.0) as described in the Lasentec manual, issued February 2000. Software setup and sample analysis is performed using Windows software (Windows XP, version 2002) in the WINDOWS manual. When the particles are collected as solid particles they are uniformly dispersed in deionized water so the test can be performed.

(2) Mean Particle Size for Solid Particles with a Broad Particle Size Distribution Between 10 and 3000 Microns

Items needed:
Particle size analyzer Analysette 3 PRO (Fritsch GmbH, Germany).
Testing sieves with sequential sieve opening of 2000, 1000, 500, 250, 125, 63 microns (Endecotts LTD, United Kingdom).
Receiving Pan to collect particles below 63 micron.

Procedure
1. Weigh 100±1 grams of particles into a weighing container on an electric balance.
2. Weigh all sieves on an electric balance and record the initial weight of each sieve.
3. Place 100±1 grams of particles sample on top of the particle size analyzer.
4. Close the sieves with the clamping unit.
5. Turn the power on and set the vibration height at 2.5 mm and the time at 5 min.
6. Press the start button. After 5 min the Vibration of the Particle Size analyzer will automatically stop.
7. After 5 minutes, record final weight of each sieve using the following table

TABLE 1
Track of weight for mean particle size determination
Measurement

| | | | | |
|---|---|---|---|---|
| | Sieve | | | |
| | sixe | initial | final | X = Initial − final |
| Sieve | (Micron) | wt. | wt. | wt |

| | |
|---|---|
| 1 | 2000 |
| 2 | 1000 |
| 3 | 500 |
| 4 | 250 |
| 5 | 125 |
| 6 | 63 |
| Pan | |

8. Calculate the difference between the final sieve weight and the initial sieve weight for each sieve.
9. Replicate each measurement at least 3 times
10. Calculate the mean particle size of each particle size range. Wherein the mean particle size for each range ( X̅ᵢ) is defined as:

$${\overline{X}}_{i} = \frac{{\sum }_{i = 1}^{n} {X}_{i}}{n}$$

Wherein n is the number of measurements, in this case 3, X is the initial−final Weight as specified in the table above and i is an integer for the sieve size used
11. Calculate the particle size diameter average ( X̅). In order to calculate the particle size diameter average, particle size ranges with less than 5% of particles and particles in the pan are disregard.

$$\overline{X} = \frac{\begin{matrix}2000 * {\overline{X}}_{2000} + 1000 * {\overline{X}}_{1000} + 500 * {\overline{X}}_{500} + \\ 250 * {\overline{X}}_{250} + 125 * {\overline{X}}_{125} + 63 * {\overline{X}}_{63}\end{matrix}}{100}$$

(3) Benefit Agent Release Test

Materials and Instruments Needed:
1. launder-o-meter (launder-o-meter procedures are described in the Technical Manual of the AATCC)
2. Test pieces of soiled fabric 10×10 cm as described in JAOCS, Vol. 66, n.1 (January 1989)
3. A canister of 50 steel balls of 6 mm diameter
4. Industrial water (2.5 mmol/L hardness)
5. Detergent composition containing particles having a core comprising a benefit agent.

Procedure:

Prepare a stainless-steel launder-o-meter container and add 250 mL of water at 30° C., 2.5 g of a liquid detergent composition containing particles containing a benefit agent, three test pieces of soiled fabric 10×10 cm and 50 steel balls. Containers are place in the launder-ometer and they are rotated for 40 minutes at 42 rpm. Every 5 minutes a sample is taken for analytical measurement of the benefit agent. The analysis is performed in accordance with the applicable protocol that is listed below:

A. Analytical Test for Preformed Peracids, Bleach Activators and Hydrogen Peroxide Sources:

Hydrogen peroxide in liquid bleaches liberates iodine from an acidified potassium iodide solution. The free iodine is titrated potentiometrically with a standardized thiosulphate solution

Bleach component+2I⁻+2H⁺→I₂+2H₂O [1]

I₂+I⁻ [symbol] I₃⁻ [2]

I₃⁻+2S₂O₃2⁻→3I⁻+S₄O₆ [3]

The bleach component can be a hydrogen peroxide source, a preformed peracid or a peracid generated by a bleach activator. The method measures the total amount of bleach. In case the bleach is generated from a bleach activator reacting with hydrogen peroxide, Catalase needs to be added after the peracid generation. Catalase destroys hydrogen peroxide without influencing the peracid and only the peracid is present for further analysis.

Equipment:
Autotitrator (fe Metrohm 809) connected to a computer
Redox electrode (fe Metrohm 6.0431.100)

Chemicals:
Glacial Acetic Acid (VWR 1.00063)
KI 3 M (Sigma Aldrich 35175)
Na₂S₂O₃ 0.01 N (38243, Sigma Aldrich)
Catalase from bovine lever Fluka Biochemica 60640±260000 U/mL
Sodium percarbonate 10% aqueous solution. In order to prepare this solution, add 100 grams sodium carbonate (VWR ALFAA16045) to 900 mL deionized water under continuous stirring.

Procedure:
1. Hydrogen peroxide sources and preformed peracids in absence of additional hydrogen peroxide:
   a. weigh x grams of sample in order to have between 0.05 and 1 grams of benefit agent.
   b. Add 50 mL water
   c. Add 10 mL of acetic acid.
   d. Stir for 1 minute
   e. Add 4 mL of KI solution
   f. Titrate with Na₂S₂O₃ with the redox electrode until the first equivalent point
   g. Calculate the release index of peroxide/peracid:

$$Release index = \frac{V \cdot N \cdot {M}_{w}}{G \cdot 2000}$$

wherein V is the measured volume in mL, N is the normality of the sodium thiosulfate solution, Mw the molecular weight of the preformed peracid or the hydrogen peroxide source and G the grams, based on 100% purity, of the preformed peracid or the hydrogen peroxide source weight for the titration.
2. In situ formed peracids (in situ reaction of hydrogen peroxide and a bleach activator)
   a. Weigh x grams of sample in order to have between 0.05 and 1 grams of benefit agent.
   b. Add 50 mL of percarbonate solution
   c. Stir for 10 minutes (to enable peracid formation)
   d. Add 0.5 mL of Catalase
   e. Stir for at least 1 minute (maximum 5 minutes)
   f. Add 10 mL of acetic acid
   g. Add 4 mL KI solution
   h. Titrate with Na₂S₂O₃ with the redox electrode until the first equivalent point
   i. Calculate the release index of peracid:

$$Release index = \frac{V \cdot N \cdot {M}_{w}}{G \cdot 2000}$$

wherein V is the measured volume in mL, N is the normality of the sodium thiosulfate solution, Mw the molecular weight of the bleach activator and G the grams, based on 100% purity, of the bleach activator weight for the titration.

B. Analytical Test for Metal Catalysts: Photometric Method

The activity of the bleach catalyst is measured by means of a colorimetric reaction with a specific dye.
a. Preparation of a calibration curve: Add 40 μL of a 10,000 ppm detergent solution like the ones described in examples 4, 5 and 6, without particles containing X ppm of the metal catalyst in deionized water to 150 μL of Chicago sky blue reagent and incubate at 37° C. for 3 minutes (see table below). After incubation an absorbance measure of the solution of detergent and dye is made at 600 nm (Abs 1). Add 60 μL of the hydrogen peroxide reagent to the solution and incubate at 37° C. for 30 minutes. Measure the absorbance of this solution at 600 nm after incubation (Abs 2). Repeat this with different levels of metal catalyst according to following table:

TABLE 2
Data for calibration curve

| | | | | |
|---|---|---|---|---|
| | X ppm metal | | | |
| Sample | catalyst | Abs 1 | Abs 2 | ABS = Abs 1 − Abs 2 |

| | |
|---|---|
| 0 | 0 |
| 1 | 0.05 |
| 2 | 0.10 |
| 3 | 0.20 |
| 4 | 0.30 |
| 5 | 0.40 |
| 6 | 0.50 |
| 7 | 0.60 |
| 8 | 0.80 |
| 9 | 1.00 |
| 10 | 1.25 |
| 11 | 1.50 |
| 12 | 1.75 |
| 13 | 2.00 |
| 14 | 2.50 |
| 15 | 3.00 |

Subtract the initial measured absorbance (Abs 1) from the final (Abs 2) and plot a calibration curve (polynomial fit).
b. Measure 40 μL of the sampled wash solution and determine the concentration of metal catalyst in the wash by using the calibration curve.
c. Determine the release index:

$$Release index = \frac{{C}_{wash}}{{C}_{total}}$$

wherein C_{wash} is the concentration determined in the wash in ppm and Cₜₒₜₐₗ is the total amount of metal catalyst in the wash in ppm (total encapsulated).

C. Analytical test for bleach boosters: Isoquinolinium class materials and the activated intermediate can be measured by mass spectrometry. Depending upon the response of the individual molecule, electrospray mass spectrometry operated in positive or negative ion is used to measure the isoquinolinium and the oxidized intermediate. MS analysis is done either by direct infusion or by injecting discrete amounts of diluted sample (flow injection analysis). No HPLC separation is needed.
a. Eluents: acetonitrile:water (1/1)+1 mmol ammonium acetate.
b. Instrument settings are optimized for individual molecules to obtain maximum response.
c. Subsequent measurements are done either in selective ion mode or multiple reaction monitoring.
d. Samples are diluted in acetonitrile/water 1/1+1 mmol ammonium acetate. Dilution factor depends upon concentration of the isoquinolinium.
e. MS setup: electrospray in either positive or negative ion mode. When full scan acquisition is desired, both scan modes are alternated.

Release index is calculated using the same formula as described above for metal catalysts.

D. Analytical test for diacyl peroxides: Diacyl peroxides are measured by means of HPLC separation followed by electrochemical detection. A short chain RP column is used for the separation, 5 μm, 250 mm*4.6 mm A typical eluent is water/acetonitrile (250 mL/850 mL) with 0.0025 M ammonium dihydrogen phosphate. The flow rate is set up to 1.0 mL/min and the detection is done by DC amperometry or colorimetry. Samples are diluted in a mixture of acetonitrile and acetic acid glacial in a ratio of 90% acetonitrile and 10% acetic acid glacial prior to analysis. Release index is calculated using the same formula as described above for metal catalysts

E. Enzyme release index may be measured using ASTM method D0348-89 (2003).

(4) Stability Index Determination of Benefit Agent on Storage

The amount of benefit agent left upon storage of particles containing these benefit agents in a laundry detergent composition, can be determined filtering the particles from the liquid detergent composition, breaking said particles to release the benefit agent and analyzing the amount left of benefit agent upon storage by using standard analytical methods as described below.

Conditions stability test: samples containing 1% of benefit agent in particle form are stored 7 days at 30° C. in a laundry detergent composition.

Filtration: After 7 days at 30° C. samples are filtered using an 8 microns filter (Whatman Int. LTD, supplied by VWR). Particles are rinsed twice with 3 mL of water. Particles breakage for benefit agent release: Filter paper containing the particles is introduced in a 250 mL glass pot and 100 mL of deionized water is added. A metal ball of 4 cm diameter (Imes, Belgium) is introduced in the glass pot and the glass pot is closed. The mixture containing the particles is kept at 45° C. for 1 hour in a thermo shaker at 135 rpm (Thermo shaker THO 5, Gerhardt) for complete benefit agent release.

Stability index determination: Benefit agent is analyzed according analytical methods described below.

A. Analytical Test for Preformed Peracids, Bleach Activators and Hydrogen Peroxide Sources:

Hydrogen peroxide in liquid bleaches liberates iodine from an acidified potassium iodide solution. The free iodine is titrated potentiometrically with a standardized thiosulphate solution

Bleach component+2I⁻+2H⁺→I₂+2H₂O [1]

I₂+I⁻ [symbol] I₃⁻ [2]

I₃⁻+2S₂O₃2⁻→3I⁻+S₄O₆ [3]

The bleach component can be a hydrogen peroxide source, a preformed peracid or a peracid generated by a bleach activator. The method measures the total amount of bleach. In case the bleach is generated from a bleach activator reacting with hydrogen peroxide, Catalase needs to be added after the peracid generation. Catalase destroys hydrogen peroxide without influencing the peracid and only the peracid is present for further analysis.

Equipment:
Autotitrator (fe Metrohm 809) connected to a PC
Redox electrode (fe Metrohm 6.0431.100)

Chemicals:
Glacial Acetic Acid (VWR 1.00063)
KI 3 M (Sigma Aldrich 35175)
Na₂S₂O₃ 0.1 N (VWR 1.09147)
Catalase from bovine lever Fluka Biochemica 60640±260000 U/mL
Sodium percarbonate 10% aqueous solution. In order to prepare this solution, add 100 grams sodium carbonate (VWR ALFAA16045) to 900 mL deionized water under continuous stirring.

Procedure:
3. Hydrogen peroxide sources and preformed peracids in absence of additional hydrogen peroxide:
   a. weigh x grams of sample (broken aged particles) in order to have between 0.5 and 1 grams of benefit agent.
   b. Add 50 mL water
   c. Add 10 mL of acetic acid.
   d. Stir for 1 minute
   e. Add 4 mL of KI solution
   f. Titrate with Na₂S₂O₃ with the redox electrode until the first equivalent point
   g. Calculate the stability index of peroxide/peracid:

$$stability index = \frac{V \cdot N \cdot {M}_{w}}{G \cdot 2000}$$

wherein V is the measured volume in mL, N is the normality of the sodium thiosulfate solution, Mw the molecular weight of the preformed peracid or the hydrogen peroxide source and G the grams, based on 100% purity, of the preformed peracid or the hydrogen peroxide source weight for the titration.
4. In situ formed peracids (in situ reaction of hydrogen peroxide and a bleach activator)
   a. Weigh x grams of sample (broken aged particles) in order to have between 0.5 and 1 grams of benefit agent.
   b. Add 50 mL of percarbonate solution
   c. Stir for 10 minutes (to enable peracid formation)
   d. Add 0.5 mL of Catalase
   e. Stir for at least 1 minute (maximum 5 minutes)
   f. Add 10 mL of acetic acid
   g. Add 4 mL KI solution
   h. Titrate with Na₂S₂O₃ with the redox electrode until the first equivalent point
   i. Calculate the stability index of peracid:

$$S tability index = \frac{V \cdot N \cdot {M}_{w}}{G \cdot 2000}$$

wherein V is the measured volume in mL, N is the normality of the sodium thiosulfate solution, Mw the molecular weight of the bleach activator and G the grams, based on 100% purity, of the bleach activator weight for the titration.

B. Analytical test for metal catalysts: Photometric Method

The activity of the bleach catalyst is measured by means of a colorimetric reaction with a specific dye.
a. Preparation of a calibration curve: Add 40 μL of a 10.000 ppm detergent solution like the ones described in examples 4, 5 and 6, without particles containing X ppm of the metal catalyst in deionized water to 150 μL of Chicago sky blue reagent and incubate at 37° C. for 3 minutes (see table below). After incubation an absorbance measure of the solution of detergent and dye is made at 600 nm (Abs 1). Add 60 μL of the hydrogen peroxide reagent to the solution and incubate at 37° C. for 30 minutes. Measure the absorbance of this solution at 600 nm after incubation (Abs 2). Repeat this with different levels of metal catalyst according to following table:

TABLE 3
Data for calibration curve

| | | | | |
|---|---|---|---|---|
| | X ppm metal | | | |
| Sample | catalyst | Abs 1 | Abs 2 | ABS = Abs 1 − Abs 2 |

| | |
|---|---|
| 0 | 0 |
| 1 | 0.05 |
| 2 | 0.10 |
| 3 | 0.20 |
| 4 | 0.30 |
| 5 | 0.40 |
| 6 | 0.50 |
| 7 | 0.60 |
| 8 | 0.80 |
| 9 | 1.00 |
| 10 | 1.25 |
| 11 | 1.50 |
| 12 | 1.75 |
| 13 | 2.00 |
| 14 | 2.50 |
| 15 | 3.00 |

Subtract the initial measured absorbance (Abs 1) from the final (Abs 2) and plot a calibration curve (polynomial fit).
b. Measure 40 μL of the broken aged particles and determine the concentration of metal catalyst in the wash by using the calibration curve.
c. Determine the stability index:

$$Stability index = \frac{{C}_{aged particles}}{{C}_{total}}$$

wherein C_{aged particles} is the concentration of metal catalyst determined inside the particles after storage in the liquid detergent composition in ppm and Cₜₒₜₐₗ is the total amount of metal catalyst in the liquid detergent composition in ppm (total encapsulated).

C. Analytical test for bleach boosters: Isoquinolinium class materials and the activated intermediate can be measured by mass spectrometry. Depending upon the response of the individual molecule, electrospray mass spectrometry operated in positive or negative ion is used to measure the isoquinolinium and the oxidized intermediate. MS analysis is done either by direct infusion or by injecting discrete amounts of diluted sample (flow injection analysis). No HPLC separation is needed.
f. Eluens: acetonitrile:water (1/1)+1 mmol ammonium acetate.
g. Instrument settings are optimized for individual molecules to obtain maximum response.
h. Subsequent measurements are done either in selective ion mode or multiple reaction monitoring.
i. Samples are diluted in acetonitrile/water 1/1+1 mmol ammonium acetate. Dilution factor depends upon concentration of the isoquinolinium.
j. MS setup: electrospray in either positive or negative ion mode. When full scan acquisition is desired, both scan modes alternated.

Stability index is calculated using the same formula as described above for metal catalysts.

D. Analytical test for diacyl peroxides: Diacyl peroxides are measured by means of HPLC separation followed by electrochemical detection. A short chain RP column is used for the separation, 5 μm, 250 mm*4.6 mm A typical eluent is water/acetonitrile (250 mL/850 mL) with 0.0025M ammonium dihydrogen phosphate. The flow rate is set up to 10 mL/min and the detection is done by DC amperometry or colorimetry. Samples are diluted in a mixture of acetonitrile and acetic acid glacial in a ratio of 90% acetonitrile and 10% acetic acid glacial prior to analysis. Stability index is calculated using the same formula as described above for metal catalysts

E. Enzyme stability index may be measured using ASTM method D0348-89 (2003).

(5) Centrifuge Retention Capacity (CRC) Test Method

Centrifuge retention capacity may be measured using test method EDANA 441.2-02

(6) pH Measurement of a Liquid Detergent Composition

pH measurement of a liquid detergent composition may be measured using test method EN 1262.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### Making Single Capsules 50 Wt % Core/50 Wt % Coating

Single granules of PAP (Eureco™ MG grade, Solvay) are coated using a double-layer technique, where the first layer is Xanthan gum (Kelzan ASX-T, CPKelco) and the second layer is polyvinyl acetate (Sigma-Aldrich, MW˜167,000 g/mol). PAP coated particles are prepared as follow: a PAP granule of about 0.05 grams is covered with about 0.10 grams of a 10% xanthan gum aqueous gel. This aqueous gel is prepared by adding 9 grams of MilliQ water to 1 gram of xanthan gum. The homogeneous gel is obtained by heating 5 hours at 40° C. in a close container without stirring. The whole surface of the PAP granule is completely covered by the gel. After drying this first layer for 72 hours at 25° C. on a teflon surface, 0.40 grams of a 40% polyvinyl acetate gel in ethanol (this gel is prepared by adding 6 grams of ethanol (96%, So.Co.Fi.) to 4 grams of polyvinyl acetate and then heating at 40° C. until a homogeneous gel is obtained) is applied. After drying this second layer for 48 hours at 25° C. on a teflon surface, the particle is stored in about 2 mL of a liquid laundry composition as described in example 5 and is kept in an oven (Micra 9, ISCO) at 30° C. for 1 week. Stability index is determined using the method described above. The value is 1.0.

### Example 2

### Making an Encapsulate 50 Wt % Core/50 Wt % Coating

PAP (Eureco™ MG grade, Solvay) is coated with two polymers using a fluid bed coater with wurster. Two polymeric solutions are prepared. First, a 2% xanthan gum aqueous solution is prepared by weighting 8 grams xanthan gum powder (Kelzan ASX-T, CPKelco) to 392 grams demi water at 50° C. under continuous stifling. Addition is done in 3 hours. Secondly, an 8% polyvinyl acetate solution in acetone/water is prepared by adding 400 grams polyvinyl acetate (MW˜167,000 g/mol, Sigma-Aldrich) to 920 grams acetone and 3680 grams demi water under continuous stirring.

A fluid bed coater with wurster (4M8-Fluidbed, ProCepT, Belgium) is used to coat the PAP. Hot air is set up at 60° C. 400 grams PAP are fluidized and when the system is ready, spraying from the bottom of 400 grams xanthan gum solution begins at a rate of 3 mL/min. When spraying from xanthan gum solution is finished, particles are dried at 60° C. for 10 minutes. Then, spraying of 5000 grams polyvinyl acetate in acetone/water solution begins at a flow rate of 5 mL/min. Material is collected and analyzed by SEM (TM-1000, Hitachi) to ensure a homogenous coating. Release index is 0.88, calculated using above described method.

### Example 3

### Production of Particles Using a Fluid Bed Coater with Wurster

PAP (Eureco™ MG grade, Solvay) is coated with two polymers using a fluid bed coater with wurster. First, an Alcogum® L-229 acrylate based emulsion copolymer is used for the inner coating. Then, a 10% Polyvinyl alcohol aqueous solution is prepared by adding 100 grams polyvinyl alcohol (M_{w} average≈13,000-26,000, ref. 363170, Sigma-Aldrich) to 900 grams demi-water under continuous stirring at 50° C.

A fluid bed coater with wurster (4M8-Fluidbed, ProCepT, Belgium) is used to coat the PAP. Hot air inlet is set up at 60° C. System is pre-heated with 70 grams PAP fluidized inside the fluid bed coater. When the system is stable, spraying from the bottom of 40 grams Alcogum® L-229 begins at a rate of 0.5 mL/min. When spraying from Alcogum® L-229 is finished, particles are dried at 60° C. for 10 minutes. Spraying of 600 grams polyvinyl alcohol aqueous solution begins at a flow rate of 1.5 mL/min. Material is collected and analyzed and stability index is determined in a liquid formulation as the one in example 4, by the method described above. Stability index is 0.95.

### Examples 4, 5 and 6

### Liquid Detergent Composition

Non-limiting examples of product formulations containing an encapsulated benefit agent summarized in the following table

| | Example 4 | Example 5 | Example 6 |
|---|---|---|---|
| | Dosage | | |
| | 40 mL | 35 mL | 31 mL |
| Ingredients | Weight % | | |
| C₁₁₋₁₆ Alkylbenzene | 20.0 | 12.5 | 22.0 |
| sulfonic acid | | | |
| C₁₂₋₁₄ Alkyl sulfate | | 2.0 | |
| C₁₂₋₁₄ alkyl 7- | 17.0 | 17.0 | 19.0 |
| ethoxylate | | | |
| C₁₂₋₁₄ alkyl ethoxy 3 | 7.5 | | 8.0 |
| sulfate | | | |
| Citric acid | 0.9 | 1.0 | 2.0 |
| C₁₂₋₁₈ Fatty acid | 13.0 | 18.0 | 18.0 |
| Sodium citrate | | 4.0 | |
| enzymes | 0-3.0 | 0-3.0 | 0-3.0 |
| Ethoxylated | 2.2 | | |
| Polyethylenimine¹ | | | |
| Hydroxyethane | 0.6 | 0.5 | 2.2 |
| diphosphonic acid | | | |
| Amphiphilic | 2.5 | | 3.5 |
| alkoxylated grease | | | |
| cleaning polymer² | | | |
| Ethylene diamine | | | 0.4 |
| tetra(methylene | | | |
| phosphonic) acid | | | |
| Brightener | 0.2 | 0.3 | 0.3 |
| Perfume | 0.4 | | |
| microcapsules⁴ | | | |
| Particles (50% | 1.5 | 2.3 | 1.7 |
| Eureco ™ MG)³ | | | |
| Water | 9 | 5 | 10 |
| CaCl₂ | | | 0.01 |
| Perfume | 1.7 | 0.6 | 1.6 |
| Hydrogenated castor | 0.4 | 0.3 | 0.3 |
| oil | | | |
| Minors (antioxidant, | 2.0 | 4.0 | 2.3 |
| sulfite, aesthetics, . . . ) | | | |

| | |
|---|---|
| Buffers | To pH 8.0 |
| (monoethanolamine) | |
| Solvents (1,2 | To 100 parts |
| propanediol, ethanol) | |

¹Polyethylenimine (MW = 600) with 20 ethoxylate groups per —NH.
²PG617 or PG640 (BASF, Germany)
³coated particles as described in examples 1, 2 and 3.
⁴Perfume microcapsules can be prepared as follows: 25 grams of butyl acrylate-acrylic acid copolymer emulsifier (Colloid C351, 25% solids, pka 4.5-4.7, Kemira Chemicals, Inc. Kennesaw, Georgia U.S.A.) is dissolved and mixed in 200 grams deionized water. The pH of the solution is adjusted to pH of 4.0 with sodium hydroxide solution. 8 grams of partially methylated methylol melamine resin (Cymel 385, 80% solids, Cytec Industries West Paterson, New Jersey, U.S.A.) is added to the emulsifier solution. 200 grams of perfume oil is added to the previous mixture under mechanical agitation and the temperature is raised to 50° C. After mixing at higher speed until a stable emulsion is obtained, the second solution and 4 grams of sodium sulfate salt are added to the emulsion. This second solution contains 10 grams of butyl acrylate-acrylic acid copolymer emulsifier (Colloid C351, 25% solids, pka 4.5-4.7, Kemira), 120 grams of distilled water, sodium hydroxide solution to adjust pH to 4.8, 25 grams of partially methylated methylol melamine resin (Cymel 385, 80% solids, Cytec). This mixture is heated to 70° C. and maintained overnight with continuous stirring to complete the encapsulation process. 23 grams of acetoacetamide (Sigma-Aldrich, Saint Louis, Missouri, U.S.A.) is added to the suspension.

### Examples 7, 8 and 9

### Unit Dose Composition

Compositions from examples 4, 5 and 6 are enclosed within a PVA film. In one aspect, the film used in the present examples is Monosol M8630 76 μm thickness.

### Examples 10 and 11

### Unit Dose Composition

The following are examples of unit dose executions wherein the liquid composition is enclosed within a PVA film. In one aspect, the film used in the present examples is Monosol M8630 76 μm thickness.

| | Example 10 | | | Example 11 | | |
|---|---|---|---|---|---|---|
| | Compartment | | | | | |
| | 1 | 2 | 3 | 4 | 5 | 6 |
| | Dosage | | | | | |
| | 34.0 | 3.5 | 3.5 | 25.0 | 1.5 | 4.0 |
| Ingredients | Weight % | | | | | |
| C₁₁₋₁₆ Alkylbenzene | 20.0 | 20.0 | 20.0 | 20.0 | 25.0 | 30.0 |
| sulfonic acid | | | | | | |
| C₁₂₋₁₄ alkyl 7- | 17.0 | 17.0 | 17.0 | 17.0 | 15.0 | 10.0 |
| ethoxylate | | | | | | |
| C₁₂₋₁₄ alkyl ethoxy 3 | 7.5 | 7.5 | 7.5 | 7.5 | 7.5 | |
| sulfate | | | | | | |
| Citric acid | 0.5 | | 2.0 | | | 2.0 |
| C₁₂₋₁₈ Fatty acid | 13.0 | 13.0 | 13.0 | 18.0 | 10.0 | 15.0 |
| enzymes | 0-3.0 | 0-3.0 | 0-3.0 | 0-3.0 | | |
| Ethoxylated | 2.2 | 2.2 | 2.2 | | | |
| Polyethylenimine¹ | | | | | | |
| Hydroxyethane | 0.6 | 0.6 | 0.6 | | 2.2 | |
| diphosphonic acid | | | | | | |
| Ethylene diamine | | | | 0.4 | | |
| tetra(methylene | | | | | | |
| phosphonic) acid | | | | | | |
| Amphiphilic | 3.5 | | | 2.5 | | |
| alkoxylated grease | | | | | | |
| cleaning polymer | | | | | | |
| Brightener | 0.2 | 0.2 | 0.2 | 0.3 | | |
| Perfume | 0.4 | | | | | |
| microcapsules | | | | | | |
| Particles (50% | 1.9 | | | | 5.0 | 5.0 |
| Eureco ™ MG)³ | | | | | | |
| Water | 9 | 8.5 | 10.0 | 10.0 | 10.0 | 9 |
| CaCl2 | | | | | 0.01 | |
| Perfume | 1.7 | 1.7 | | 1.5 | 0.5 | |
| Hydrogenated castor | 0.4 | | 0.1 | | 0.3 | 0.3 |
| oil | | | | | | |
| Minors (antioxidant, | 2.0 | 2.0 | 2.0 | 2.2 | 2.2 | 2.0 |
| sulfite, aesthetics, . . .) | | | | | | |

| | |
|---|---|
| Buffers | To pH 8 |
| (monoethanolamine) | |
| Solvents (1,2 | To 100 parts |
| propanediol, ethanol) | |

¹Polyethylenimine (MW = 600) with 20 ethoxylate groups per —NH.
²PG617 or PG640 (BASF, Germany)
³coated particles as described in examples 2 and 3.
⁴Perfume microcapsules preparation is described in examples 4, 5 and 6.

### Example 12

Comparison between mono- and dual-encapsulation, using single capsules making Single granules of PAP (Eureco™ MG grade, Solvay) are coated using a unique-layer, where the layer is polyvinyl acetate (Sigma-Aldrich, MW ˜167,000 g/mol). PAP coated particles are prepared as follow: a PAP granule of about 0.05 grams is covered with about 0.40 grams of a 40% polyvinyl acetate gel in ethanol (this gel is prepared by adding 6 grams of ethanol (96%, So.Co.Fi.) to 4 grams of polyvinyl acetate and then heating at 40° C. until a homogeneous gel is obtained) is applied. After drying this layer for 48 hours at 25° C. on a Teflon surface, the particle is stored in about 2 mL of a liquid laundry composition as described in example 5 and is kept in an oven (Micra 9, ISCO) at 30° C. for 1 week. Stability index is determined using the method described above. The value is 0.2. Thus, it is clear that the use of a material sink as the first layer of the particle unexpectedly improves the benefit agent's stability and, as a result, overall performance of a composition comprising the particle:

TABLE 4
Stability comparison between mono- and dual-layer encapsulation

| | | | Stability index in |
|---|---|---|---|
| Particle | 1^{st} layer | 2^{nd} layer | formula of example 5 |
| Example 1 | Kelzan ASX-T | Polyvinyl acetate | 1.0 |
| Example 12 | none | Polyvinyl acetate | 0.2 |

### Examples 13, 14, 15 and 16

### Single Particles Stability Index

The stability index of the particles of 13-16 (which are made per the process of Examples 1 and 9) is determined to be as follows:

| | Benefit | | Weight % | | Weight % | Stability index in |
|---|---|---|---|---|---|---|
| Particle | agent (core) | 1^{st} layer | 1^{st} layer* | 2^{nd} layer | 2^{nd} layer* | formula of example 17 |
| Ex. 13 | PAP² | Kelzan | 7.0 | Polyvinyl | 43.0 | 0.99 |
| | | ASX-T | | acetate¹ | | |
| Ex. 14 | PAP² | Kelzan | 3.0 | Polyvinyl | 47.0 | 0.75 |
| | | HP-T | | acetate¹ | | |
| Ex. 15 | PAP² | Kelzan | 30.0 | Polyvinyl | 40.0 | 0.86 |
| | | ASX | | acetate¹ | | |
| Ex. 16 | PAP² | Kelzan | 4.0 | Cellulose | 51.0 | 0.96 |
| | | ASX-T | | acetate³ | | |

*weight based on total particle weight
¹Sigma-Aldrich, MW ~167,000 g/mol
²Eureco MG
³cellulose acetate ~30,000 g/mol, Sigma Aldrich.

### Examples 17 and 18

### Liquid Detergent Composition

Non-limiting examples of product formulations containing an encapsulated benefit agent summarized in the following table

| | |
|---|---|
| Example 17 | Example 18 |

Dosage

| | |
|---|---|
| 25 mL | 25 mL |

| | |
|---|---|
| Ingredients | Weight % |

| | | |
|---|---|---|
| Monoethanolamine: | 37.0 | 35.0 |
| C₁₂₋₁₅ EO•3•SO₃H | | |
| Monoethanolamine: | 5.9 | 6.0 |
| C₁₆₋₁₇ highly soluble | | |
| alkyl sulfate | | |
| C₁₂₋₁₄ dimethylamine- | 1.7 | 1.7 |
| N-oxide | | |
| Ethoxylated | 3.9 | 4.0 |
| Polyethyleneimine¹ | | |
| Citric acid | | 2.0 |
| Amphiphilic | 3.9 | 2.5 |
| alkoxylated grease | | |
| cleaning polymer² | | |
| C₁₂₋₁₈ Fatty acid | 3.0 | |
| Suds suppression | 0.1 | 0.1 |
| polymer | | |
| C₁₁₋₈ HLAS | 13.4 | 10.0 |
| HEDP | | 1.0 |
| Tiron | 2.0 | |
| Brightener | 0.1 | 0.2 |
| Perfume | 2.3 | |
| microcapsules⁴ | | |
| Particles (50% | 5.6 | 5.6 |
| Eureco ™ MG)³ | | |
| Water | 4.7 | 5.0 |
| Perfume | 1.5 | 1.7 |
| External structuring | 0.4 | 0.2 |
| system | | |
| Minors (antioxidant, | 1.5 | 1.5 |
| sulfite, aesthetics, . . . ) | | |

| | |
|---|---|
| Buffers | To pH 8.0 |
| (monoethanolamine) | |
| Solvents (1,2 | To 100 parts |
| propanediol, ethanol) | |

¹Polyethyleneimine (MW = 600 grams/mol) with 20 ethoxylate groups per —NH (BASF, Germany)
²PG617 or PG640 (BASF, Germany)
³coated particles as described in examples 2 and 3.
⁴Perfume microcapsules preparation is described in examples 4, 5 and 6.

### Examples 19 and 20

### Unit Dose Composition

The following are examples of unit dose executions wherein the liquid composition is enclosed within a PVA film. In one aspect, the film used in the present examples is Monosol M8630 76 μm thickness.

| | Example 19 | | | Example 20 | | |
|---|---|---|---|---|---|---|
| | Compartment | | | | | |
| | 7 | 8* | 9* | 10 | 11 | 12* |
| | Dosage | | | | | |
| | 34.0 | 3.5 | 3.5 | 25.0 | 1.5 | 4.0 |
| Ingredients | Weight % | | | | | |
| C₁₁₋₁₆ Alkylbenzene | 20.0 | | | 20.0 | | |
| sulfonic acid | | | | | | |
| C₁₂₋₁₄ alkyl 7- | 17.0 | | | 17.0 | | |
| ethoxylate | | | | | | |
| C₁₂₋₁₄ alkyl ethoxy 3 | 7.5 | | | 7.5 | | |
| sulfate | | | | | | |
| Citric acid | 2.0 | | | | | |
| C₁₂₋₁₈ Fatty acid | 13.0 | | | 18.0 | | |
| enzymes | 0-3.0 | | | 0-3.0 | | |
| Ethoxylated | 2.2 | | | | | |
| Polyethylenimine¹ | | | | | | |
| Hydroxyethane | 0.6 | | | | | |
| diphosphonic acid | | | | | | |
| Amphiphilic | 2.3 | | | | | |
| alkoxylated grease | | | | | | |
| cleaning polymer² | | | | | | |
| Ethylene diamine | | | | 0.4 | | |
| tetra(methylene | | | | | | |
| phosphonic) acid | | | | | | |
| Brightener | 0.2 | | | | 1.5 | |
| Perfume | 0.4 | | | | | |
| microcapsules⁴ | | | | | | |
| Particles (50% | 1.9 | 100 | 100 | | | 100 |
| Eureco ™ MG)³ | | | | | | |
| Water | 9 | | | 10.0 | | |
| CaCl2 | | | | | | |
| Perfume | 1.7 | | | 1.5 | | |
| Hydrogenated castor | 0.4 | | | | | |
| oil | | | | | | |
| Minors (antioxidant, | 2.0 | | | 2.2 | | |
| sulfite, aesthetics, . . .) | | | | | | |

| | |
|---|---|
| Buffers | To pH 8 |
| (monoethanolamine) | |
| Solvents (1,2 | To 100 parts |
| propanediol, ethanol, | |
| glycerol) | |

¹Polyethyleneimine (MW = 600 grams/mol) with 20 ethoxylate groups per —NH (BASF, Germany)
²PG617 or PG640 (BASF, Germany)
³coated particles as described in examples 2 and 3.
⁴Perfume microcapsules preparation is described in examples 4, 5 and 6.
*no pH adjustment and no solvents are added to these compartments

### Example 21

### Comparison Between Mono- and Dual-Encapsulation, Using Single Capsules Making

Using the same particles' making process as described in Examples 1 and 12, mono- and dual-capsules are prepared.

TABLE 5
Stability comparison between mono- and dual-layer encapsulation

| | | | Stability index in |
|---|---|---|---|
| Particle | 1^{st} layer | 2^{nd} layer | formula of example 5 |
| A | 3% xanthan salt | 47% Polyvinyl | 0.87 |
| | tolerant | alcohol¹ | |
| B | none | 50% Polyvinyl | 0.34 |
| | | alcohol¹ | |

¹Polyvinyl alcohol, M_{w} average≈13,000-26,000, ref. 363170, Sigma-Aldrich

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A particle comprising a shell and a core, said shell comprising a first layer and a second layer, said first layer encapsulating said core and comprising a material sink, said second layer encapsulating said first layer and comprising a barrier material, said particle having a particle diameter of from about 150 microns to about 3000 microns.

2. The particle of claim 1 wherein:
a) said material sink comprises a material selected from the group consisting of a water soluble and/or water dispersible non-reducing polysaccharide, a water soluble and/or water dispersible acrylate derivative and mixtures thereof;
b) said barrier material comprises a material selected from the group consisting of polyvinyl alcohol, polyvinyl acetate, cellulose acetate, poly(vinyl-alcohol-co-vinylacetate), acrylic acid-ethylene-vinyl acetate copolymer and mixtures thereof; and
c) said core material comprises a material selected from the group consisting of a preformed peracid, a metal catalyst, a bleach activator, a bleach booster, a diacyl peroxide, a hydrogen peroxide source and an enzyme.

3. The particle of claim 2 wherein:
a) said metal catalyst comprises a material selected from the group consisting of dichloro-1,4-diethyl-1,4,8,11-tetraaazabicyclo[6.6.2]hexadecane manganese(II); dichloro-1,4-dimethyl-1,4,8,11-tetraaazabicyclo[6.6.2]hexadecane manganese(II) and mixtures thereof;
b) said bleach booster comprises a material selected from the group consisting of 2-[3-[(2-hexyldodecyl)oxy]-2-(sulfooxy)propyl]-3,4-dihydroisoquinolinium, inner salt; 3,4-dihydro-2-[3-[(2-pentylundecyl)oxy]-2-(sulfooxy)propyl]isoquinolinium, inner salt; 2-[3-[(2-butyldecyl)oxy]-2-(sulfooxy)propyl]-3,4-dihydroisoquinolinium, inner salt; 3,4-dihydro-2-[3-(octadecyloxy)-2-(sulfooxy)propyl]isoquinolinium, inner salt; 2-[3-(hexadecyloxy)-2-(sulfooxy)propyl]-3,4-dihydroisoquinolinium, inner salt; 3,4-dihydro-2-[2-(sulfooxy)-3-(tetradecyloxy)propyl]isoquinolinium, inner salt; 2-[3-(dodecyloxy)-2-(sulfooxy)propyl]-3,4-dihydroisoquinolinium, inner salt; 2-[3-[(3-hexyldecyl)oxy]-2-(sulfooxy)propyl]-3,4-dihydroisoquinolinium, inner salt; 3,4-dihydro-2-[3-[(2-pentylnonyl)oxy]-2-(sulfooxy)propyl]isoquinolinium, inner salt; 3,4-dihydro-2-[3-[(2-propylheptyl)oxy]-2-(sulfooxy)propyl]isoquinolinium, inner salt; 2-[3-[(2-butyloctyl)oxy]-2-(sulfooxy)propyl]-3,4-dihydroisoquinolinium, inner salt; 2-[3-(decyloxy)-2-(sulfooxy)propyl]-3,4-dihydroisoquinolinium, inner salt; 3,4-dihydro-2-[3-(octyloxy)-2-(sulfooxy)propyl]isoquinolinium, inner salt; 2-[3-[(2-ethylhexyl)oxy]-2-(sulfooxy)propyl]-3,4-dihydroisoquinolinium, inner salt and mixtures thereof;
b) said bleach activator comprises a material selected from the group consisting of tetraacetyl ethylene diamine (TAED); benzoylcaprolactam (BzCL); 4-nitrobenzoylcaprolactam; 3-chlorobenzoyl-caprolactam; benzoyloxybenzenesulphonate (BOBS); nonanoyloxybenzenesulphonate (NOBS); phenyl benzoate (PhBz); decanoyloxybenzenesulphonate (C₁₀-OBS); benzoylvalerolactam (BZVL); octanoyloxybenzenesulphonate (C₈-OBS); perhydrolyzable esters; 4-[N-(nonaoyl)amino hexanoyloxy]-benzene sulfonate sodium salt (NACA-OBS); dodecanoyloxybenzenesulphonate (LOBS or C₁₂-OBS); 10-undecenoyloxybenzenesulfonate (UDOBS or C₁₁-OBS with unsaturation in the 10 position); decanoyloxybenzoic acid (DOBA); (6-octanamidocaproyl)oxybenzenesulfonate; (6-nonanamidocaproyl) oxybenzenesulfonate; (6-decanamidocaproyl)oxybenzenesulfonate and mixtures thereof;
c) said preformed peracid comprises a material selected from the group consisting of peroxymonosulfuric acids; perimidic acids; percabonic acids; percarboxilic acids and salts of said acids;
d) said diacyl peroxide comprises a material selected from the group consisting of dinonanoyl peroxide, didecanoyl peroxide, diundecanoyl peroxide, dilauroyl peroxide, dibenzoyl peroxide, di-(3,5,5-trimethyl hexanoyl)peroxide and mixtures thereof;
e) said hydrogen peroxide source comprises a material selected from the group consisting of a perborate, a percarbonate, a peroxyhydrate, a persulfate and mixtures thereof, and
f) said enzyme comprises a material selected from the group consisting of peroxidases, proteases, lipases, phospholipases, cellobiohydrolases, cellobiose dehydrogenases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases and mixtures thereof.

4. The particle of claim 2 wherein:
a) said polyvinyl alcohol comprises a polyvinyl alcohol variant having a degree of hydrolysis from about 80 mol % to about 99 mol %; and a molecular weight from about 10,000 gram/mol to about 750,000 gram/mol;
b) said polyvinyl acetate comprises a polyvinyl acetate variant having a degree of polymerization from about 150 to about 5,000;
c) said cellulose acetate comprises a cellulose acetate variant having a molecular weight from about 30,000 gram/mol to about 50,000 gram/mol.

5. The particle of claim 2 wherein;
a) said water soluble and/or water dispersible non-reducing polysaccharide comprises a material selected from the group consisting of xanthan gum, diutan gum, guar gum, gellan gum, carrageenan, synergistic gum systems and mixtures thereof; and
b) said water soluble and/or water dispersible acrylate derivative has a glass transition temperature from about 50° C. to about 130° C.

6. The particle of claim 2, said material sink having a centrifuge retention capacity of from about 2 gram/gram to about 500 gram/gram.

7. The particle of claim 2, said particle having a stability index of from about 0.80 to about 1.

8. The particle of claim 1, said particle having a release index of from about 0.25 to about 1.

9. The particle of claim 1, said particle having a core to shell mass ratio of from about 5:95 to about 80:20.

10. The particle of claim 1, said particle having a material sink to barrier material mass ratio of from about 20:80 to about 3:97.

11. The particle of claim 1, said particle comprising a third layer, said third layer comprising a second barrier material.

12. A consumer product comprising the particle of claim 1 and an adjunct ingredient.

13. A consumer product according to claim 12, wherein at least 75% of said particles have a particle wall thickness of from about 1 to about 500 microns.

14. A consumer product according to claim 12, said consumer product comprising a material selected from the group consisting of a structurant, an anti-agglomeration agent and mixtures thereof.

15. A consumer product according to claim 14, wherein said structurant comprises a hydrogenated castor oil derivative.

16. A consumer product according to claim 12, said consumer product comprising a material selected from:
a) an anionic surfactant and/or a nonionic surfactant;
b) a solvent;
c) water; and
d) optionally one or more materials selected from the group consisting of:
(i) a bleach compatible clay clean polymer;
(ii) a brightener;
(iii) a builder; and
(iv) a chelant.

17. A consumer product according to claim 12, wherein said consumer product comprises:
a. from 0.0001% to 8% by weight of a detersive enzyme, and
b. has a neat pH from 6.5 to 10.5.

18. A consumer product according to claim 17, wherein said detersive enzyme comprises an enzyme selected from the group consisting of: lipase, protease, amylase, cellulase, pectate lyase, xyloglucanase, and mixtures thereof.

19. A consumer product according to claim 12, wherein said consumer product comprises:
a. from 0.1% to 12% by weight of the bleach or bleach system, and
b. has a neat pH of from 6.5 to 10.5.

20. A consumer product according to claim 12, wherein said consumer product is enclosed within a water soluble pouch material.

21. A method of treating and/or cleaning a situs, said method comprising:
a. optionally washing and/or rinsing said situs;
b. contacting said situs with a consumer product according to claim 12; and
c. optionally, washing and/or rinsing said situs.

22. A situs treated with a consumer product according to claim 12.

23. A process of making a consumer product that comprises a consumer product adjunct material and a particle, said process comprising:
a) preparing a first solution comprising, based on total solution weight, from about 0.5% to about 10% of a material sink that is suspended and/or dissolved in said first solution, and one or more solvents;
b) preparing a second solution comprising, based on total solution weight, from about 2% to about 20% of a barrier material that is suspended and/or dissolved in said second solution, and one or more solvents;
c) optionally, preparing a third solution comprising, based on total solution weight, from about 2% to about 20% of a barrier material that is suspended and/or dissolved in said third solution, and one or more solvents;
d) optionally, combining an anti-agglomeration agent with said first, second and/or third solution;
e) optionally, forming a first composition by agglomerating a core material and a binder;
f) fluidizing said core material or said first composition in a chamber at a temperature of from about 25° C. to about 90° C.;
g) forming a second composition by spraying said first solution on said fluidized core material or said first composition;
h) fluidizing said second composition in a chamber at a temperature of from about 25° C. to about 90° C.;
i) forming a third composition by spraying said second solution on said second composition;
j) optionally, fluidizing said third composition in a chamber at a temperature of from about 25° C. to about 90° C.;
k) optionally, forming a fourth composition by spraying said third solution on said third composition;
l) optionally, forming a fifth composition by agglomerating said third and/or fourth composition; and
m) combining said third, fourth and/or fifth composition with one or more consumer product adjuncts.
